(19) United States
(12) Patent Application Publication
(10) Pub. No.: US 2025/0064238 A1
(43) Pub. Date: Feb. 27, 2025

(54) A HOLDER FOR VESSELS

(71) Applicants: Andrew Jonathan STEVENS, Flagstaff Hill (AU); Victoria Jane Latham, Flagstaff Hill (AU)

(72) Inventors: Andrew Jonathan STEVENS, Flagstaff Hill (AU); Victoria Jane Latham, Flagstaff Hill (AU)

(21) Appl. No.: 18/720,531

(22) PCT Filed: Dec. 9, 2022
(86) PCT No.: PCT/AU2022/051478

§ 371 Date: Jun. 14, 2024

(30) Foreign Application Priority Data
Dec. 17, 2021 (AU) 2021904112

(51) Int. Cl. A47G 23/02; A45F 5/02

(52) U.S. Cl. CPC A47G 23/0266; A45F 5/021; A47G 23/0225; A45F 2200/0583

(57) ABSTRACT

The present invention relates to a holder configured to hold vessels, including liquid drinking vessels such as cans and bottles, in a substantially upright configuration whilst being attached to a user or any supporting object to enable the user to free their hand(s) and engage in other activities. The holder is configured to securely accommodate vessels of a plurality of different shapes and sizes and to prevent spillage of the contents of the vessel.

### FIELD OF THE INVENTION

The present invention relates to a holder for vessels, including liquid vessels such as cans and bottles. In particular, the present invention relates to a holder for holding cans, bottles and the like in a substantially upright configuration whilst being attached to a user or any supporting object to enable the user to free their hand(s) and engage in other activities. The holder is configured to securely accommodate vessels of a plurality of different shapes and sizes and to prevent spillage of the contents of the vessel.

### BACKGROUND OF THE INVENTION

In many circumstances where liquid needs to be accessed from a can, bottle, cup or similar vessel, there is no suitable flat surface upon which to safely and securely place the vessel. Various means of holding and retaining liquid vessels have been developed to address this problem. For example, most automobiles and other passenger vehicles include cup holders shaped as cylindrical receptacles provided in doors and centre consoles to receive cups. Cup holders are also available as a bicycle accessory and function to secure beverage containers to bicycle frames during travel. However, car and bicycle beverage container holders tend to be purpose built and are generally not usable in other applications that may require the holder to be attached to the user's clothing or other type of supporting object, for example. Whilst various holding devices exist that aim to secure liquid vessels, none that are known to the Applicant provide users with the ability to place/retrieve a liquid vessel in a manner that is accessible, comfortable, safe and secure, and usable across a wide range of different applications.

This is particularly true when the vessel is a beverage container and when the beverage consumption is occurring at a live event, for example. At live events, users often carry their beverage containers in their hands whilst walking and when viewing the event, which is not preferable since users prefer to use their hand(s) to engage in activities such as eating, taking photographs, and other activities that may be difficult or impossible whilst using one or both hands to carry the beverage container. It is also difficult to carry multiple beverage containers at once, which may be necessary when one person purchases multiple beverages for a group of people.

Problems also arise when attempting to place vessels of different shapes and sizes into known holders. For example, beverage containers are available in a variety of different shapes and sizes, including cans, bottles and cups, yet holders that are known to the Applicant are incapable of safely and securely accommodating all of these shapes.

Another problem can arise after certain vessels are opened. For example, in the case of most cans, once they are opened there is no easy way of sealing the opening again. Therefore, when using conventional holders, opened vessels such as opened cans become vulnerable to spillage particularly when subjected to excessive motion. The Applicant is not aware of any holding device that enables placement of open vessels in a manner that is accessible, comfortable, safe and secure, and which also prevents liquid inside the vessel from spilling.

Currently in the market there are various devices which seek to provide secure placement/retrieval of liquid vessels, such as straps, belts, holders, and brackets, but none that are known to the Applicant address the problems described above. For example, many existing devices make it awkward to remove drinks, and cannot accommodate varying sizes and shapes easily (which often results in the vessel being held unevenly and thereby vulnerable to falling out of the device or causing the contents of the vessel to spill). They also tend to consist of multiple components, making them costly to manufacture, and difficult and/or time consuming to assemble.

It is an object of the present invention to overcome at least some of the aforementioned problems or to provide the public with a useful alternative.

The reference to any prior art in this specification is not, and should not be taken as, an acknowledgement or any suggestion, that the prior art forms part of the common general knowledge.

### SUMMARY OF THE INVENTION

In a first aspect, the present invention provides a holder for a vessel, the holder including:
a longitudinal axis;
   a rear wall portion that extends substantially longitudinally and includes an attachment means for enabling the holder to be attached to a supporting object;
   a base portion that extends in a forwards direction relative to the rear wall portion, the base portion configured to extend beneath a vessel accommodated by the holder to prevent the vessel from moving longitudinally in a substantially downwards direction;
   side wall portions that extend in the forwards direction relative to the rear wall portion such that the side wall portions extend along the sides of a vessel being carried by the holder and then inwardly to an area in front of the vessel, the side wall portions being sufficiently resilient to allow the side wall portions to separate if a cross-sectional dimension of the vessel exceeds the cross-sectional dimension of the holder side wall portions, the side wall portions thereby accommodating vessels of varying cross-sectional dimension;
   a top portion that extends in the forwards direction relative to the rear wall portion, the top portion configured to:
      when the vessel or a shoulder thereof does not exceed the height of the top portion, extend over a top of the vessel or the shoulder to restrict the vessel from moving longitudinally in a substantially upwards direction, or
      when the vessel exceeds the height of the top portion and does not include a shoulder that is engageable by the top portion, apply a force against a rear wall area of the vessel and thereby urge the vessel in the forwards direction, causing each of the top portion and the side wall portions of the holder to apply an opposing force against the front and rear of the vessel respectively, thereby gripping the vessel and restricting radial and upward longitudinal movement thereof.

In an embodiment, the vessel holds liquid and/or solid contents.

Accordingly, the present invention provides a holder for carrying a vessel to thereby free a user's hand, whilst also securing the vessel in a manner that prevents or at least retards spillage (particularly when the user moves, e.g. walks, jogs, runs, jumps, etc). In the case of a vessel that exceeds the height of the top portion or is of a greater cross-sectional dimension than the holder, the side wall portions will flex. The more the side wall portions are flexed, the greater the opposing force that will be applied to the front wall area of the vessel. In other words, as the material is flexed, a force is applied by the side wall portions on a front wall area of the vessel that is substantially equal to a force applied by the top portion on the radially opposed rear wall area of the vessel, causing the respective holder portions to grip the vessel even when the vessel has smooth sides. The extent to which the side wall portions flex will be equal to or less than the strength of the rear wall area of the vessel (assuming the vessel is open), therefore the holder will provide a gripping force that is suitable for the vessel being carried, making it possible to remove and replace the vessel many times without damage to the holder, and without becoming dangerous or causing injury to the user.

In an embodiment, the holder is substantially cylindrical in shape to accommodate a vessel of substantially circular cross section.

In an embodiment, an example of a vessel that exceeds a height of the top portion is a cylindrical drinking bottle, and an example of a vessel that does not exceed the height of the top portion is a cylindrical drinking can.

In an embodiment, the base portion projects forwardly from the rear wall portion of the holder and thereby provides support for the vessel by preventing longitudinal movement of the vessel beyond the base portion.

In an embodiment, the base portion projects substantially perpendicularly from the rear wall portion of the holder and provides a flat supporting surface for a vessel being carried by the holder.

In an embodiment, the base portion extends sufficiently forwardly from the rear wall portion of the holder to enable the base portion, when the base portion is placed upon a substantially horizontal surface, to support the holder in a substantially upright configuration.

In an embodiment, the base portion further includes one or more feet associated with said base portion, positioned adjacent the rear wall portion of the holder to provide support for the holder in said upright configuration.

In an embodiment, the side wall portions are in the form of two resilient flaps extending in a curved configuration substantially forwardly from the rear wall portion of the holder, the two resilient flaps shaped to journal around a vessel carried by the holder and terminate inwardly at the front of the vessel where the flaps define an opening.

In an embodiment, the holder is configured to accept vessels being inserted from the front of the holder where the vessel is inserted through the opening in a rearwards motion, or from above the holder where the vessel is inserted in a downwards longitudinal motion.

In an embodiment, when the vessel is inserted in a rearwards direction through the opening at the front of the holder, and the vessel cross-sectional dimension does not exceed the internal dimension of the flaps, the flaps are caused to extend radially outwardly from a rest position to an extended position which allows rearward movement of the vessel through the opening, the flaps being sufficiently resilient to return to their rest position after the vessel is fully inserted.

In an alternative embodiment, when the vessel is inserted in a rearwards direction through the opening at the front of the holder, or inserted from above the holder in a downwards longitudinal direction, and the vessel cross-sectional dimension exceeds the internal dimension of the flaps, the flaps remain in an extended position for as long as the vessel remains in the holder.

In an embodiment, the top portion is in the form of a lip that curves upwardly and forwardly from a top of the rear wall portion of the holder.

In an embodiment, the lip is a curved extension of the rear wall portion of the body.

In an embodiment, when the vessel exceeds the height of the lip, the lip applies a radial force upon the rear wall of the vessel to cause the vessel to push radially against an internal surface of the two resilient arms which are of sufficient rigidity to oppose the radial force, thereby maintaining the vessel in a state in which radial and upward longitudinal movement of the vessel is prevented or at least minimised.

In an embodiment, when the vessel does not exceed the height of the lip, or includes a shoulder that does not exceed the height of the lip, the lip acts to prevent or at least minimise upward longitudinal movement of the vessel or the shoulder of the vessel.

In an embodiment, the attachment means is in the form of a hook that extends rearwardly and then downwardly from the rear wall portion of the body such that a space is created between the rear wall portion of the body and the downward extension of the hook for receiving the supporting object.

In an embodiment, the downward extension of the hook includes, at a free end thereof, a barb that extends forwardly and upwardly towards the rear wall portion of the holder, the barb providing a means of preventing the supporting object from moving out of the space.

In an embodiment, the supporting object is made of a non-rigid material, and the rear of the body includes a kink that is located so as to receive a surface portion of the non-rigid material when the barb is caused to press the material towards the rear wall portion of the holder, which facilitates preventing the supporting object from moving out of the space.

In an embodiment, an example of a supporting object made of non-rigid material is an item of clothing such as a belt or trouser waist, wherein the holder is hooked onto the belt or trouser waist such that the belt or trouser waist extends inside the space.

In an embodiment, an example of a supporting object made of a rigid material is a solid component associated with a vehicle such as a pram or car, wherein the holder is hooked onto the component such that the component extends inside the space.

In an embodiment, the holder further includes a receptacle attachment including at least one receptacle configured to be placed over an opening in the vessel being carried by in the holder, for preventing liquid from exiting the vessel through said vessel opening. An opening in the vessel will be created when the vessel is manually opened, e.g. after the stay-tab of a can is opened, or after a bottle cap is unscrewed and removed from the bottle.

In an embodiment, the receptacle attachment includes a plurality of receptacles of different size and/or configuration to suit correspondingly sized and/or configured vessel openings.

In an embodiment, the receptacle is configured to fit over an end of a can to thereby prevent or at least minimise liquid exiting through the can opening beyond the receptacle.

In an embodiment, the receptacle is configured to fit over an end of a bottle having its cap removed to thereby prevent or at least minimize the contents of the vessel exiting through the bottle opening beyond the receptacle.

In an embodiment, the receptacle attachment includes a first receptacle configured to fit over an end of a can to thereby prevent the contents exiting through the can opening beyond the first receptacle, and a second receptacle configured to fit over an end of a bottle having its cap removed to thereby prevent the contents of the bottle exiting through the bottle opening beyond the second receptacle, the receptacle attachment thereby capable of sealing the opening of both a can and a bottle.

In an embodiment, the receptacle attachment is fastened to the holder body by a flexible band configured such that, the band is of sufficient length to enable the receptacle to be used to seal the opening of a vessel that does not exceed the height of the top portion, or, the band is of sufficient length to enable the receptacle to be used to seal the opening of a vessel that does exceed the height of the top portion, or, the band is of sufficient length and/or resilience to enable the receptacle to be used to seal the opening of vessels of varying heights.

In an embodiment, the receptacle attachment is fastened to the lip that projects upwardly and forwardly from the rear wall portion of the holder body.

In an embodiment, each receptacle associated with the receptacle attachment includes one or more apertures for enabling passage of air to inside an open vessel. This is to allow gasses to escape and thereby enable carbonated drinks, for example, to breath. By covering an open drinking vessel, for example, the receptacle may also ensure that foreign matter does not enter the contents of the vessel and can act to prevent drink spiking and the like.

In an embodiment, the holder includes means of wirelessly transmitting and/or receiving data, and may include its own processor and storage. For example, the holder may store, generate and/or receive data, and transmit same to an external destination such as an external server or a mobile device. An example of data that may be stored, generated and/or received by the holder includes position/movement tracking data, and in this regarding a tracking module may be fixed to the holder. Where children are provided with a holder at a night-time event, for example, the tracking module may be programmed to transmit tracking data to a mobile or similar device associated with a parent or guardian to enable the parent or guardian to track the motion or locate the whereabouts of their child. Additional types of data may be stored, generated, received and/or transmitted by the holder including, for example, information relating to a particular event being attended by a user, including the facilities, eateries, etc., at the particular event location.

In an embodiment, the holder may include a battery for powering any processor. The battery may also power other accessories including one or more light emitting diodes (LEDs) for example.

In an embodiment, the holder body may display advertising. For example, the two resilient flaps extending substantially forwardly from the rear wall portion of the holder body may include an extended longitudinal surface area for displaying such advertising.

In a second aspect, the present invention provides a holder for a drinking can or bottle, the holder including:
a longitudinal axis;
a rear wall portion that extends substantially longitudinally and includes an attachment means for enabling the holder to be attached to a supporting object;
a base portion that extends in a forward direction relative to the rear wall portion, the base portion configured to extend beneath the can or bottle accommodated by the holder to prevent the can or bottle from moving longitudinally in a substantially downward direction;
side wall portions that extend in a forward direction relative to the rear wall portion and which extend around the sides of the can or bottle to an area in front of the can or bottle, the side wall portions being sufficiently resilient to allow the side wall portions to separate in the event a cross-sectional dimension of the can or bottle exceeds the cross sectional dimension of the holder side wall portions whilst being inserted or carried, and thereby accommodate cans or bottles of varying cross-sectional dimension;
a top portion configured to:
   when a can is inserted in the holder, or a bottle having a shoulder that does not exceed the height of the top portion, extend over a top of the can or the bottle shoulder to restrict the can or bottle from moving longitudinally in a substantially upward direction, or
   when a bottle is inserted in the holder, press against the rear of the bottle and thereby urge the bottle in a forward direction causing each of the top portion and the side wall portions of the holder to apply a radially opposing force on the front and rear of the bottle respectively, thereby gripping the bottle and restricting radial and upward longitudinal movement thereof.

### BRIEF DESCRIPTION OF THE DRAWINGS

Features of the present disclosure are illustrated by way of example and not limited in the following figure(s), in which like numerals indicate like elements, in which:

FIG. 1 illustrates various different views of a vessel holder configured according to an embodiment of the present invention;

FIG. 2 illustrates additional views of the vessel holder of FIG. 1;

FIG. 3A illustrates a top view of the vessel holder of FIGS. 1 and 2, wherein the side wall portions or wings are shown in a non-extended state;

FIG. 3B illustrates a further top view of the vessel holder of FIGS. 1 and 2, and further illustrating in broken lines the side wall portions of the vessel holder in extended states;

FIG. 4A illustrates a side view of the vessel holder of FIGS. 1 to 3 carrying a liquid vessel in the form of a drinking can;

FIG. 4B illustrates a top view of the vessel holder of FIG. 4A;

FIG. 5 illustrates a side view of a vessel holder configured to accommodate a slim-line drinking can;

FIG. 6 illustrates a side view of a vessel holder carrying a liquid vessel in the form of a plastic drinking bottle;

FIG. 7 illustrates a side view of a vessel holder carrying a liquid vessel in the form of a glass drinking bottle;

FIG. 8A illustrates a standalone side view of a vessel holder configured in accordance with a further embodiment of the present invention, the vessel holder including a lid receptacle attachment and associated band of a length to accommodate tall bottles;

FIG. 8B illustrates an in-use, perspective view of the vessel holder of FIG. 8A carrying a glass drinking bottle;

FIG. 9A illustrates a standalone side view of a vessel holder configured in accordance with a further embodiment of the present invention, the vessel holder including a lid receptacle attachment and associated band of a length to accommodate a drinking can.

FIG. 9B illustrates an in-use, perspective view of the vessel holder of FIG. 9A carrying a drinking can;

FIG. 10 illustrates rear and enlarged perspective views of the vessel holder of FIGS. 1 to 2, the enlarged view illustrating a tracking module fixed to the holder;

FIG. 11 illustrates a front perspective view of the vessel holder of FIGS. 1 to 2 including advertising displayed on its side wall portions;

FIG. 12 illustrates a RHS, front, rear and LHS view of a user utilising multiple liquid vessel holders of the present invention to carry a plurality of different drinking vessels;

FIG. 13 illustrates an interior of a vehicle including multiple liquid vessel holders mounted at different locations inside the vehicle; and

FIG. 14 illustrates a pram including multiple liquid vessel holders attached to the pram at different locations.

### DETAILED DESCRIPTION OF THE EMBODIMENT(S) OF THE INVENTION

For simplicity and illustrative purposes, the present disclosure is described by referring to an embodiment thereof. In the following description, numerous specific details are set forth in order to provide a thorough understanding of the present disclosure. It will be readily apparent however, that the present disclosure may be practiced without limitation to these specific details. In other instances, some methods and structures have not been described in detail to avoid unnecessarily obscuring the present disclosure.

As used herein, the terms “a” and “an” are intended to denote at least one of a particular element, the term “includes” means includes but not limited to, the term “including” means including but not limited to, and the term “based on” means based at least in part on.

The present invention relates to a holder (10) for a vessel (12) such as a liquid vessel (e.g. can or bottle). The holder (10) includes a body (14) for accommodating the vessel (12) and defining a longitudinal axis (16). The body (14) further includes a rear wall portion (18) and an attachment means (20) for allowing the holder (10) to be attached to a supporting object (22) such as a user's belt. In this way, the holder (10) provides the user with a means of holding a vessel such as a can or bottle and thereby freeing the user's hands to perform other tasks such as taking photographs, eating food, holding a child's hand, walking a dog, carrying objects with both hands, and the like. It will become apparent that the holder (10) provides the user with an easy to access, comfortable, safe and secure location for placing their vessel.

It is to be understood that while the vessels (12) depicted and described herein are liquid vessels, including drinking cans, plastic bottles, and glass bottles, the present invention may equally be applied to other forms of vessel not necessarily configured for holding drinking liquid but for holding other types of liquids as well as solids such as food and the like. Accordingly, reference to “liquid vessel” in the description that follows is not intended to limit the present invention solely to liquid-holding vessels. Further, use of the word “vessel” is not intended to be limiting, and any container of a suitable shape similar to the shape capable of being accommodated by the holder (10) may be considered within the scope of the term “vessel”.

The holder (10) includes a base portion (24) that extends in a forward direction (25) relative to the rear wall portion (18), wherein the base portion (16) is configured to extend beneath the vessel (12) accommodated by the holder (10) to prevent the vessel (12) from moving longitudinally in a substantially downward direction (26). The holder (10) further includes side wall portions (28) (also referred to herein as wings or flaps) that extend in the forward direction (25) relative to the rear wall portion (18) and which are adapted to extend around the sides of the transported vessel (12) to an area in front of the vessel (12), the side wall portions (28) being sufficiently resilient to allow the side wall portions (28) to separate (30) in the event a cross-sectional dimension of the vessel (12) exceeds the cross-sectional dimension of the holder side wall portions (28), to thereby accommodate vessels (12) of varying cross-sectional dimension.

The holder (10) further includes a top portion (32) that extends in the forward direction (25) relative to the rear wall portion (18), wherein the function of the top portion (32) is dependant upon the height and/or configuration of the vessel (12) being carried. For example, when the vessel (12) is a liquid-holding vessel such as a drinking can which does not exceed the height of the top portion (32), the top portion (32) will extend over a top of the liquid vessel (12) to restrict the liquid vessel (12) from moving longitudinally in a substantially upward direction (36).

Similarly, if the drinking vessel includes a shoulder (34) at a similar height as compared with the height of a can, e.g. a shoulder (34) associated with a glass drinking bottle as shown in FIG. 7, the top portion (32) will extend over the shoulder (34) to restrict the liquid vessel (12) from moving longitudinally in the upward direction (36). Accordingly, it will be appreciated that the use of the base portion (24) and top portion (32) limits the longitudinal movement of the drinking vessel (12) and thereby secures the drinking vessel (12) longitudinally.

There may be circumstances where the vessel (12) exceeds the height of the top portion (32), and the side wall surface of the vessel (12) may not necessarily have a shoulder (34). In this scenario, the top portion (32) will press against the rear of the vessel (12) and thereby urge the vessel (12) in a forward direction (25) causing each of the top portion (32) and the side wall portions (28) of the holder (10) to apply an opposing force on the front and rear of the vessel (12) respectively. This results in the vessel being gripped such that radial and upward longitudinal movement thereof is restricted.

It will be appreciated that a holder (10) configured in the above described manner will be suitable for accommodating most shapes and sizes of vessels, including drinking vessels such as cans and bottles (including those having an insulating cover such as a stubbie holder) as well as other vessels including, but not limited to, paint tins for holding line-marking paint, hairspray cans for hairdressers, tubs for holding paint brushes and the like for artists, containers for holding building tools, cans of food, sauce bottles, etc.

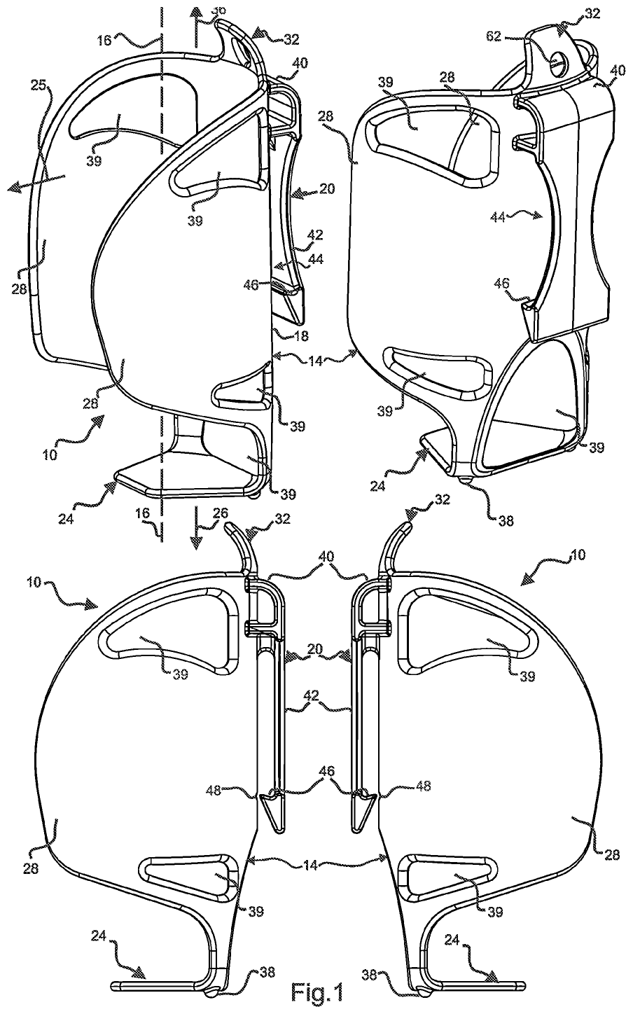

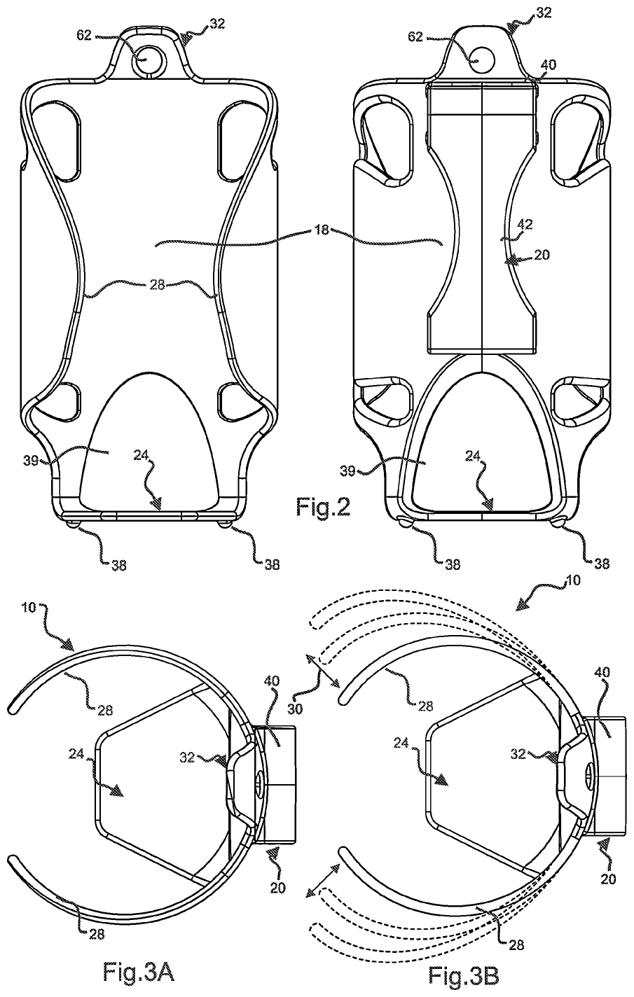

FIGS. 1 to 7 illustrate an example of a holder (10) for drinking vessels, wherein the holder (10) is configured to carry drinking vessels in particular, i.e. drinking cans, plastic bottles and glass bottles.

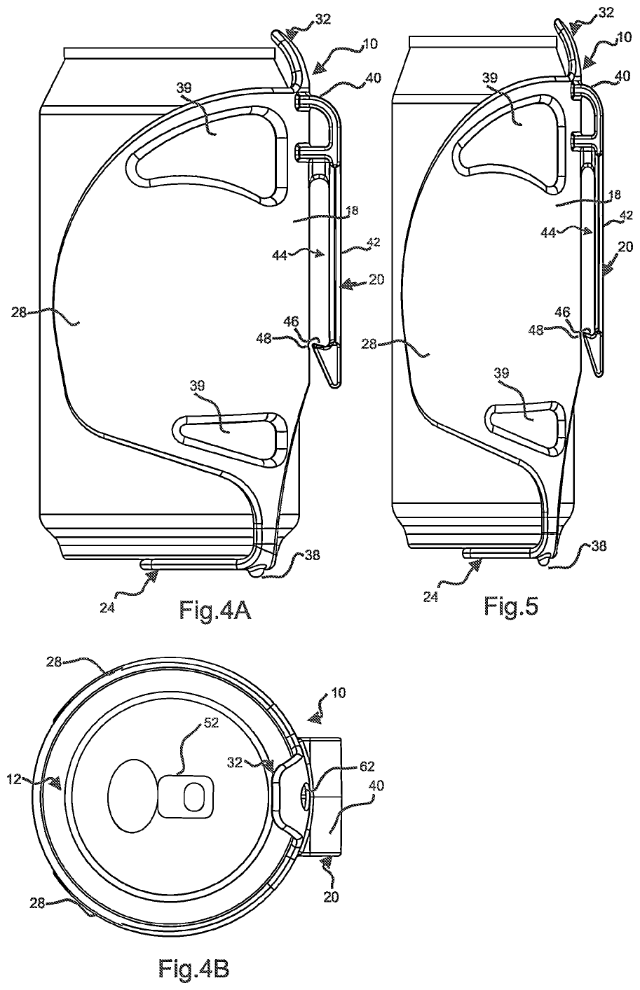

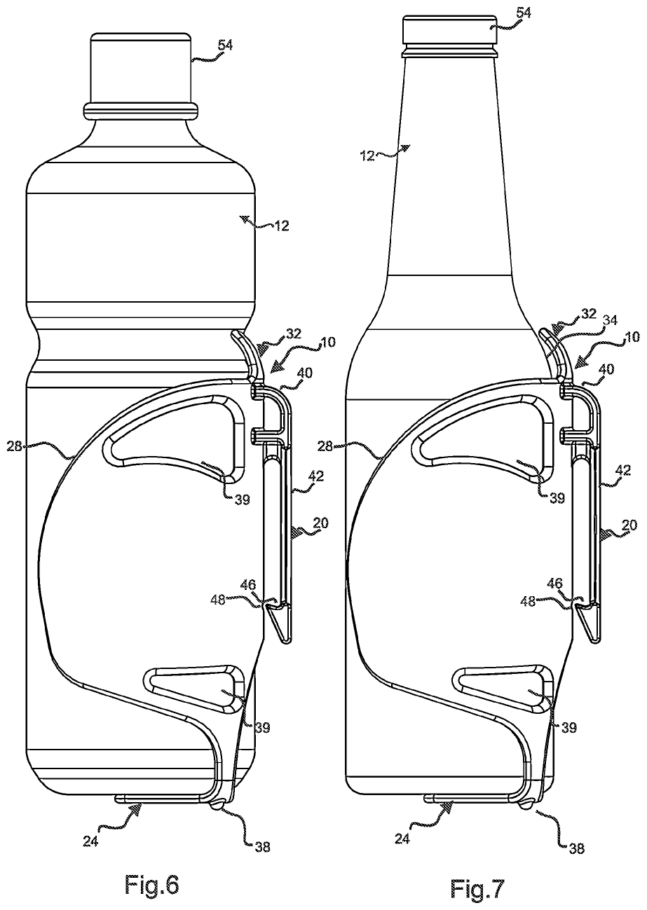

FIGS. 3A-3B illustrate an extent to which the side wall portions (28) can extend radially in order to accommodate different cross sections of can/bottle (or cover therefor such as a stubbie holder), and it is to be understood that the holder (10) could be manufactured in other shapes and sizes such that the holder can be utilised in one or more different applications. Even when using the holder (10) for a single application such as to carry drinking vessels, the holder may be required to be manufactured in different sizes and an example is shown in FIG. 5 which illustrates a narrower holder which is particularly suited to slim-line drinking cans. FIGS. 6 and 7 illustrate that the same holder (10) can be utilised for similarly shaped bottles such as the plastic drinking bottle shown in FIG. 6 and the glass drinking bottle shown in FIG. 7, with the same holder (10) also being suitable to carry cans as shown in FIGS. 4A-4B.

The holder (10) shown in FIGS. 4A, 4B, 6 and 7 is particularly sized and shaped to accommodate the more standard size of drinking cans and bottles, e.g. standard beverage cans having a height of 100 mm (for 250 ml cans) through to a height of 170 mm (for 500 ml cans). Such beverage cans have diameters of approximately 66 mm+2 mm and these standard-size cans (and equivalent standard-size bottles) can be used in the holder (10) depicted. This type of holder (10) is therefore targeted at the largest percentage of cans/bottles utilised in the market, however, if there is demand for a holder of a different size, then the holder (10) can easily be scaled up or down to suit the particular application.

It will be appreciated that even where a bottle, for example, includes a shoulder (34), the cross-sectional dimension of the bottle may be such that its dimension exceeds that of the internal dimension of the holder body (14). The skilled addressee will appreciate that the more the side wall portions (28) are flexed, the greater the load that will be applied at the front of the vessel (by the side wall portions (28)) and also at the rear of the vessel (by the top portion (32)).

In this regard, as each resilient side wing (28) is flexed, a force is applied by the side wings (28) that is substantially equal to a force applied by the top portion (32) on the radially opposed side of the vessel (12), causing the respective portions to grip the vessel. The skilled addressee will appreciate that provided the side wall portions (28) of the holder (10) are able to flex sufficiently to accommodate (without crumpling) the side wall of the vessel (12) (including when the vessel is not full or empty), the holder (10) will be adequate for the vessel (12), and it will be possible to remove and replace the vessel (12) many times without damage to the holder (10), and without becoming dangerous or causing injury to the user. In this way, even if the vessel (12) has smooth sides, the force applied to the vessel by the flexing wings along with the radially opposed force applied by the top portion (32) will secure the vessel (12) in place.

The holder (10) shown in the drawings is substantially cylindrical in cross-section, although it is to be understood that other shapes such as a square cross-section could be implemented depending upon the particular application.

The base portion (24) projects substantially perpendicularly from a lower end of the body (14) and thereby provides a flat supporting surface for the liquid vessel (12). The base portion (24) may extend sufficiently forwardly from the rear wall portion (18) to enable the base portion (24), when the base portion is placed upon a substantially horizontal surface, to support the holder (10) and any vessel (12) carried in the holder, in a substantially upright configuration. The base portion (24) may further include one or more feet (38) in the form of small knobs extending downwardly from the base portion (24) adjacent the rear wall portion (18) of the body (14) to provide additional support for the holder (10) in the upright configuration. The skilled addressee will appreciate that being able to place the holder (10) and any vessel (12) supported by the holder (10) in an upright configuration when not in use is beneficial since there is otherwise a risk of spillage when the holder (10) is not attached to the user or other supporting object and placed upon a surface.

A liquid vessel (12) may be inserted into a holder (10) in a number of different ways. For example, the liquid vessel (12) may be inserted radially through the opening at the front of the holder defined by the side wall portions (28) which are extend substantially forwardly from the rear wall portion (18) of the body (14). The resilient flaps (28) may be shaped to journal around the liquid vessel (12) and terminate in an open flap arrangement at the front of the vessel (12). When inserting a vessel (12) from the front of the container through the flaps, the flaps (28) are caused to extend (flex) radially outwardly from a rest position to an extended position, as shown in FIG. 3B, which allows for movement of the liquid vessel through the open flaps. The flaps (28) may be sufficiently resilient to return to their rest position after the liquid vessel (12) is fully inserted. Alternatively, if the liquid vessel cross-sectional dimension exceeds the internal dimension of the flaps (28), then the flaps may remain in an extended position for as long as the vessel (12) remains in the holder (10). Another method of inserting the vessel (12) is by placing the vessel (12) into the holder longitudinally from above in a direction toward the base portion (24), rather than radially though the flaps.

The top portion (32) is in the form of a lip that curves upwardly and forwardly from a top of the rear wall portion (18) of the holder body (14) and, in the particular embodiment shown, the lip (32) is effectively a curved extension of the rear wall portion (18).

Each of the portions of the body (14) may include one or more apertures (34) for functional reasons, aesthetic reasons, and/or manufacturing cost-saving purposes.

As mentioned previously, the rear wall portion (18) further includes an attachment means (20) for enabling the holder (10) to be attached to a supporting object (22). In the embodiment shown, the attachment means is in the form of a hook (20) that includes a short rearward extension (40) and then a downward extension (42) such that the hook (20) extends rearwardly a short distance and then downwardly from the rear wall portion (18) of the body (14). This configuration creates a space (44) between the rear wall portion (18) of the body (14) and the downward extension (42) of the hook (20) for receiving a supporting object (22). The downward extension (42) further includes, at or adjacent a free end thereof, a barb (46) that extends forwardly and upwardly towards the rear wall portion (18) of the holder body (14), the barb (46) providing a means of preventing or at least restricting the supporting object (22) from moving out of the space (44) once engaged.

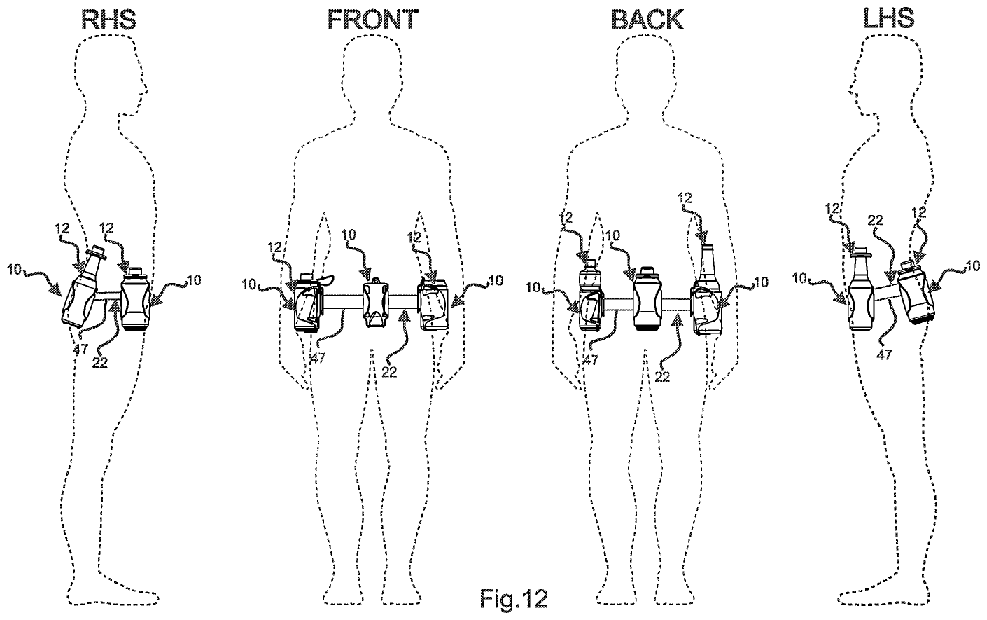

The supporting object (22) shown in FIG. 12 is in the form of a belt (47) worn by the user and is therefore made of a non-rigid material, although the supporting object (22) may well be a rigid material. Located on the rear wall portion (18) of the holder (10), in radial alignment with the tip of the barb (46), is a kink (48) that is located so as to receive a surface portion of a non-rigid supporting object (22) (such as the belt (47)) when the barb (46) is caused to press the belt material towards the rear wall portion (18) of the body (14). Locking the belt into the kink (48) in this way contributes to preventing or at least restricting the supporting object (22) from moving out of the space (44).

Some of the advantages associated with the holder (10) of the present invention should now be appreciated. Rather than being difficult or awkward to remove a vessel (12) from the holder (10), the holder enables quick and efficient removal of vessels (12). Further, the holder (10) is capable of accommodating vessels of varying size and shape, and further ensures that the vessel (12) is supported evenly and securely even if the vessel (12) is not an exact fit. The holder (10) allows for a variety of different diameters and lengths of liquid vessels to be inserted, even those that a user may prefer to be housed in an insulated cover (e.g. a stubbie holder). Because the holder (10) is constructed integrally rather than from multiple components, the holder (10) does not require assembly and can be manufactured as a one-piece flexible plastic part.

The hook is designed to fit on a large number of surfaces, materials and angles. The holder (10) can also be hooked in many different positions and can subsequently be removed easily as required and does not require any additional assistance or tool. The material used to manufacture the holder (10) may be selected based upon the environment in which the holder (10) is to be used, and materials may also be selected on the basis that they enable the environmental impact to be as low as possible. For example, the holder (10) could be made as a single-use product (e.g. from a compostable Polylactic Polybutylene Adipate-co-Terephtalate (PLA PBAT)), or made of more robust material to ensure that the holder (10) is designed for regular and prolonged use (e.g. from a recyclable material such as Polycarbonate (PC), Polypropylene (PP) or High Density Polyethylene (HDPE) or Polyethylene Terephthalate (PET) with a recycled content). The holder (10) could also be manipulated so that it is usable in a variety of other applications, and also up-cycled (i.e. re-used to create other products).

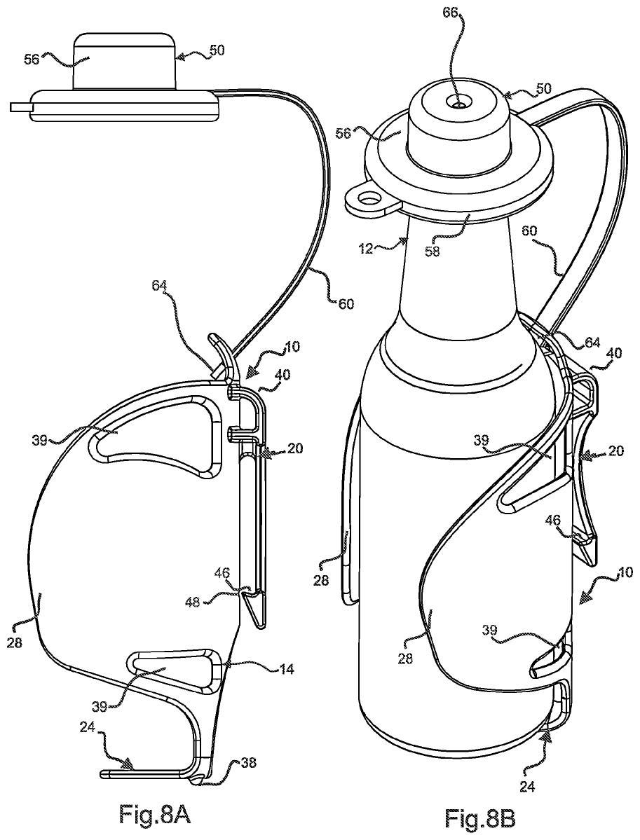

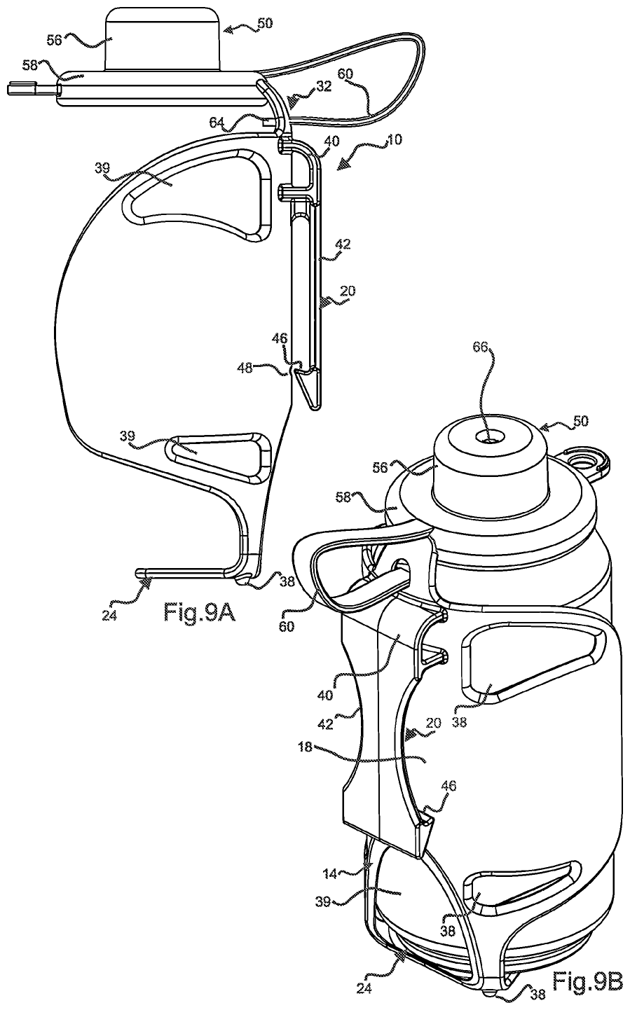

As shown in FIGS. 8 and 9, the holder (10) may further include a receptacle attachment (50) associated with the holder body (14), the receptacle attachment including a receptacle (50) configured to be placed over an opening in a vessel (12) once the vessel has been opened. This will prevent or at least minimise contents of the vessel exiting through the vessel opening. An opening in the vessel will be created when the vessel is opened, e.g. after the stay-tab (52) of a drinking can is opened, or after a cap (54) of a drinking bottle is unscrewed and removed from the bottle.

Rather than being configured for use on either a can or a bottle independently, the receptacle attachment (50) could include multiple receptacles (56) and (58) of different size and configuration to suit different vessel openings, as shown in FIGS. 8A, 8B, 9A and 9B. For example, in the embodiments shown, the receptacle attachment (50) includes a first receptacle (56) configured to fit over an open end of a bottle having its cap removed, and a second receptacle (58) configured to fit over an open end of a can, to thereby prevent or at least minimise liquid exiting the bottle/can. By sealing the opening of a can or bottle, or any other vessel upon which the receptacle attachment (50) is used, the receptacle attachment (50) ensures that foreign matter, including any airborne particles, do not enter the vessel (12). It will be appreciated that use of such a receptacle attachment (50) may also act to prevent drink spiking and similar incidents.

The receptacle (50) may be attached to the holder body (14) by any suitable means. In one implementation, the receptacle attachment (50) is attached using a flexible band (60) of sufficient length to enable the receptacle (50) to be used to seal the opening of liquid vessels of varying heights (e.g. the height of a can as well as the height of a bottle). In an alternative embodiment, the band (60) could be made resilient such that it is stretchable to accommodate taller bottles as well as shorter cans.

It is to be understood that whilst FIGS. 8A-8B and 9A-9B illustrate a receptacle attachment (50) capable of accommodating both a can and a bottle, such receptacle attachments may be configured such that they are only capable of accommodating one type of vessel as opposed to multiple different types of vessel.

FIGS. 8A-8B and 9A-9B also illustrate how the flexible band (60) may be secured to the holder (10), i.e. by insertion through an aperture (62) located in the top portion (32) of the holder (10). The aperture (62) may retain the end (64) of the flexible band (60) since the end (64) of the flexible band (60) includes an increased dimension as compared with the band and as compared with the diameter of the aperture (62), the dimension of the end (64) being sufficient to prevent withdrawal through the aperture without a threshold amount of force being applied.

The receptacle (50) may include one or more apertures (66) for enabling passage of air to inside an open vessel (12). In the case of liquid vessels holding carbonated drinks for example, the aperture (66) will allow gases to escape and thereby enable the carbonated drink to breathe.

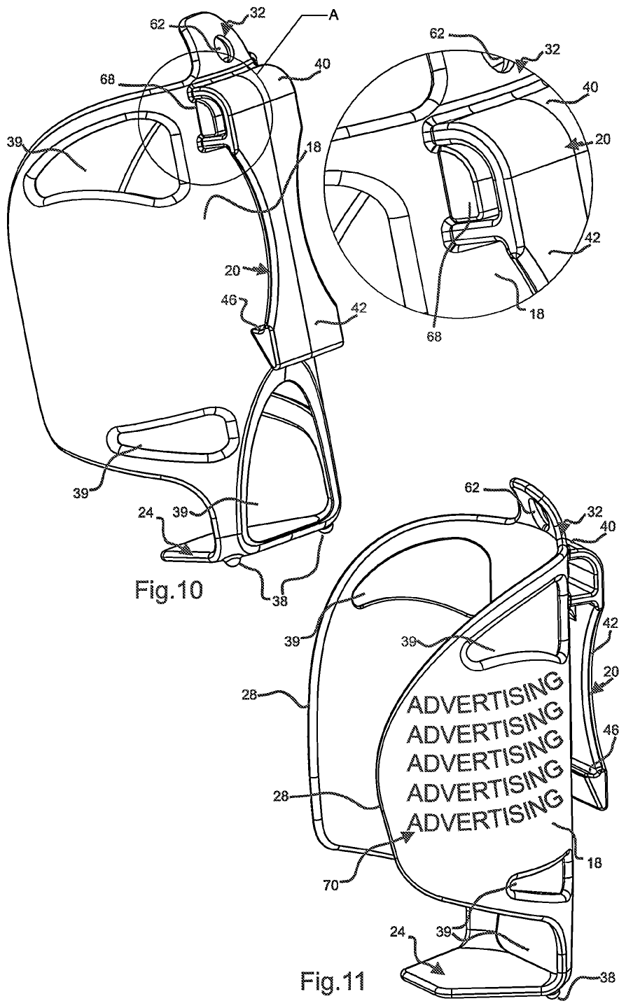

The holder (10) may include a means of wirelessly transmitting and/or receiving data, and in this regard may include its own processor and memory storage. For example, the holder (10) may store, generate and/or receive data, and transmit same to an external destination such as an external server, mobile device or the like. An example of data that may be stored, generated, received and/or transmitted by the holder (10) includes position/movement tracking data. In this regard, a tracking module (68) such as that shown in FIG. 10 nestled inside the rearward extension (40) of the hook (20) may be utilised. Where children are provided with a holder (10) at a night-time event, for example, the tracking module (68) may be programmed to transmit tracking data to a mobile phone or similar device associated with a parent or guardian, to enable the parent or guardian to track the motion and/or locate the whereabouts of their child.

Additional types of data may be stored, generated, received and/or transmitted by the holder (10). In one example, information relating to a particular event being attended by the user, including the facilities, eateries, etc, at the particular event location, may be transmitted by an event organiser and received by a processor associated with the holder (10). The holder (10) and a user's mobile device may be configured to communicate with one another, e.g. using wireless technology such as Bluetooth, and a dedicated software application operating on the user device may enable such information to be displayed to the user. Such data may be transmitted to the holder processor as soon as the holder (10) is detected as being within a particular vicinity of the event.

Different mechanisms for displaying such information to users may be possible including, for example, making such information available to the software application operating on the user device without the need to transmit same to the holder (10). For example, such information could be transmitted directly to the user's phone. However, in this embodiment, in order for location information to be transmitted to the user's phone, the holder (10) would still require a tracking module (or similar) for tracking location co-ordinates of the holder (10), and transmitting such data to the appropriate destination responsible for providing such information to the software application. For example, there may be a remote server for handling such data including receiving such data from individual holders (10) and transmitting same to user devices that are registered to use the software application and which have the relevant permissions to view such data.

The holder (10) may also include a battery (not shown) for powering a processor or any additional hardware requiring an energy source, such as one or more light emitting diodes (LEDs) (not shown). In this way, the holder (10) may also be configured to ensure increased safety at events, particularly for children, in that through the use of hardware to transmit and receive data, useful information can be transmitted and/or received including transmission of the whereabouts of the holder (10), as well as event information to appropriate emergency personnel. The holder (10) may also be equipped with flashing LEDs, for example, to enable a parent to keep track of their children at night-time events such as fireworks nights, school trips or large populated events.

FIG. 11 also illustrates the holder (10) with advertising (70) displayed on the exposed surface of the two resilient flaps (28). The ability to display promotional and advertising material in a very prominent position on the holder (10) may give rise to commercial benefits. The material (70) displayed on the holder (10) need not necessarily be limited to advertising or promotional material but could also include team colours, details of an event participant, details relating to a particular celebration including a milestone event, an anniversary, a birthday, a graduation or any private or public event.

As mentioned earlier, a typical supporting object (22) may be a belt (47) worn by a user, as shown in FIG. 12. It will be appreciated that the belt (47) in FIG. 12 is being used to support six holders (10) and therefore potentially up to six drinking vessels (12) with the ability to carry additional drinks by hand. It should be apparent from FIG. 12 that a trip to the bar to purchase a round of drinks at an event, such as a sporting event at which a group of friends have convened, is facilitated utilising the holder (10) of the present invention since multiple holders can simply be hooked onto a user's belt to carry drinks for multiple people.

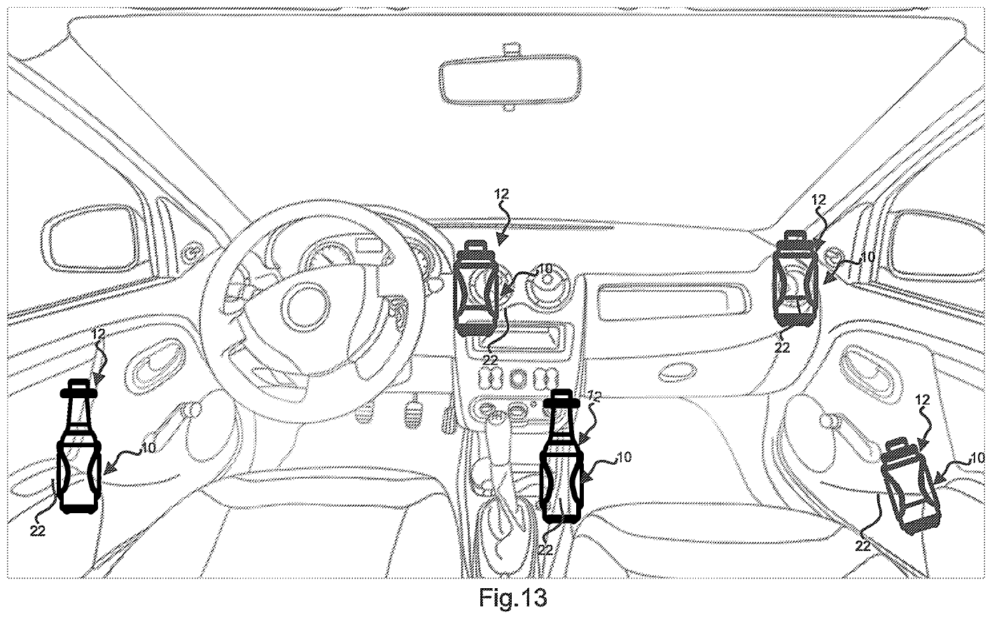

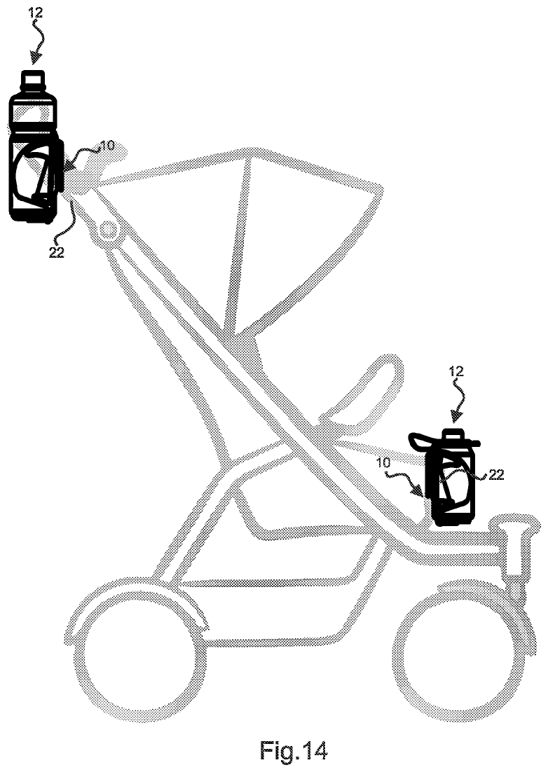

However, the supporting object (22) need not be limited to an item of clothing associated with a user. For example, FIG. 13 shows that the supporting item (22) may well be a component in a vehicle interior to which the hook (20) is able to be secured, and FIG. 14 shows that components (22) associated with a pram could also potentially be utilised to support one or more vessel holders (10). Additional supporting items which are not shown may include a shopping trolley, boat, pushbike, motorbike or scooter, camping chair, slot machine, or cinema seat.

The skilled addressee will now appreciate the various benefits associated with the holder (10) of the present invention. The holder (10) allows a user to transport a vessel (12), such as a drinking vessel (can, bottle or the like) securely and thereby provides the user with an opportunity to use both of their hands all the time. The size of the holder (10) can be increased or decreased to suit the product it needs to hold by a simple scaling operation. As previously mentioned, the invention is not limited to drinking vessels, but any container that holds contents. Additional examples of vessels (12) include a can of line marker for road workers, bait for a fisherman, fasteners for production workers on a production line, tradie tools and fasteners, chalk for free climbers, pet treats for animal trainers, etc.

The curved upper lip (32), depending on the height of the vessel (12), is configured to apply a force to the side of the vessel, which is useful since applying a slight sideways force means that the vessel will push against the flexible flaps (28) and thereby hold the vessel more securely and firmly in the holder (10), also making it safer to use. By also utilising a receptacle attachment (50) to seal off an opening in the vessel, the user is allowed more freedom to perform actions that may otherwise result in liquid or other contents of the vessel exiting the vessel through the opening. For example, the user may use the holder (10) without spilling the contents of the vessel, even when engaging in activities such as walking, jogging, running, or jumping at a live event.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A holder for a vessel, the holder including:
a longitudinal axis;
a rear wall portion that extends substantially longitudinally and includes an attachment means for enabling the holder to be attached to a supporting object;
a base portion that extends in a forwards direction relative to the rear wall portion, the base portion configured to extend beneath a vessel accommodated by the holder to prevent the vessel from moving longitudinally in a substantially downwards direction;
side wall portions that extend in the forwards direction relative to the rear wall portion such that the side wall portions extend along the sides of a vessel being carried by the holder and then inwardly to an area in front of the vessel, the side wall portions being sufficiently resilient to allow the side wall portions to separate if a cross-sectional dimension of the vessel exceeds the cross-sectional dimension of the holder side wall portions, the side wall portions thereby accommodating vessels of varying cross-sectional dimension;
a top portion that extends in the forwards direction relative to the rear wall portion, the top portion configured to:
when the vessel or a shoulder thereof does not exceed the height of the top portion, extend over a top of the vessel or the shoulder to restrict the vessel from moving longitudinally in a substantially upwards direction, or
when the vessel exceeds the height of the top portion and does not include a shoulder that is engageable by the top portion, apply a force against a rear wall area of the vessel and thereby urge the vessel in the forwards direction, causing each of the top portion and the side wall portions of the holder to apply an opposing force against the front and rear of the vessel respectively, thereby gripping the vessel and restricting radial and upward longitudinal movement thereof.

2. A holder according to claim 1, wherein the vessel holds liquid and/or solid contents.

3. A holder according to claim 1, wherein the holder is substantially cylindrical in shape to accommodate a vessel of substantially circular cross section.

4. A holder according to claim 1, wherein the base portion projects substantially perpendicularly from the rear wall portion of the holder and provides a flat supporting surface for a vessel being carried by the holder, the base portion extending sufficiently forwardly from the rear wall portion of the holder to enable the base portion, when the base portion is placed upon a substantially horizontal surface, to support the holder in a substantially upright configuration.

5. A holder according to claim 4, wherein the base portion further includes one or more feet associated with said base portion, positioned adjacent the rear wall portion of the holder, to provide support for the holder in said upright configuration.

6. A holder according to claim 1, wherein the side wall portions are in the form of two resilient flaps extending in a curved configuration substantially forwardly from the rear wall portion of the holder, the two resilient flaps shaped to journal around a vessel carried by the holder and terminate inwardly at the front of the vessel where the flaps define an opening.

7. A holder according to claim 6, wherein the holder is configured to accept vessels being inserted from the front of the holder where the vessel is inserted through the opening in a rearwards motion, or from above the holder where the vessel is inserted in a downwards longitudinal motion.

8. A holder according to claim 7, wherein when the vessel is inserted in a rearwards direction through the opening at the front of the holder, and the vessel cross sectional dimension does not exceed the internal dimension of the flaps, the flaps are caused to extend radially outwardly from a rest position to an extended position which allows rearward movement of the vessel through the opening, the flaps being sufficiently resilient to return to their rest position after the vessel is fully inserted.

9. A holder according to claim 7, wherein when a vessel is inserted in a rearwards direction through the opening at the front of the holder, or inserted from above the holder in a downwards longitudinal direction, and the vessel cross sectional dimension exceeds the internal dimension of the flaps, the flaps remain in an extended position for as long as the vessel remains in the holder.

10. A holder according to claim 6, wherein the top portion is in the form of a lip that curves upwardly and forwardly from a top of the rear wall portion of the holder.

11. A holder according to claim 10, wherein when the vessel exceeds the height of the lip, the lip applies a radial force upon the rear wall of the vessel to cause the vessel to push radially against an internal surface of the two resilient arms which are of sufficient rigidity to oppose the radial force, thereby maintaining the vessel in a state in which radial and upward longitudinal movement of the vessel is prevented or at least minimised.

12. A holder according to claim 10, wherein when the vessel does not exceed the height of the lip, or includes a shoulder that does not exceed the height of the lip, the lip acts to prevent or at least minimise upward longitudinal movement of the vessel or the shoulder of the vessel.

13. A holder according to claim 1, wherein the attachment means is in the form of a hook that extends rearwardly and then downwardly from the rear wall portion of the body such that a space is created between the rear wall portion of the body and the downward extension of the hook for receiving the supporting object.

14. A holder according to claim 13, wherein the downward extension of the hook includes, at a free end thereof, a barb that extends forwardly and upwardly towards the rear wall portion of the holder, the barb providing a means of preventing the supporting object from moving out of the space.

15. A holder according to claim 14, wherein the supporting object is made of a non-rigid material, and the rear of the body includes a kink that is located so as to receive a surface portion of the non-rigid material when the barb is caused to press the material towards the rear wall portion of the holder, which facilitates preventing the supporting object from moving out of the space.

16. A holder according to claim 1, further including a receptacle attachment including at least one receptacle configured to be placed over an opening in the vessel being carried by the holder, for preventing liquid from exiting the vessel through said vessel opening.

17. A holder according to claim 16, wherein the receptacle attachment includes a plurality of receptacles of different size and/or configuration to suit correspondingly sized and/or configured vessel openings, including a first receptacle configured to fit over an end of a can to thereby prevent the contents of the can exiting through the can opening beyond the first receptacle, and a second receptacle configured to fit over an end of a bottle having its cap removed to thereby prevent the contents of the bottle exiting through the bottle opening beyond the second receptacle, the receptacle attachment thereby capable of sealing the opening of both a can and a bottle.

18. (canceled)

19. A holder according to claim 16, wherein the receptacle attachment is attached to the holder body by a flexible band configured such that:
the band is of sufficient length to enable the receptacle to be used to seal the opening of a vessel that does not exceed the height of the top portion, or
the band is of sufficient length to enable the receptacle to be used to seal the opening of a vessel that does exceed the height of the top portion, or
the band is of sufficient length and/or resilience to enable the receptacle to be used to seal the opening of vessels of varying heights.

20. A holder according to claim 1, further including a data processor, a battery for powering the data processor, a means of wirelessly transmitting data to and/or wirelessly receiving data from an external server and/or mobile device, and a location tracking module enabling location data to be transmitted to the external server and/or mobile device.

21. (canceled)

22. (canceled)

23. A holder for a drinking can or bottle, the holder including:
a longitudinal axis;
a rear wall portion that extends substantially longitudinally and includes an attachment means for enabling the holder to be attached to a supporting object;
a base portion that extends in a forwards direction relative to the rear wall portion, the base portion configured to extend beneath the can or bottle accommodated by the holder to prevent the can or bottle from moving longitudinally in a substantially downward direction;
side wall portions that extend in a forwards direction relative to the rear wall portion and which extend around the sides of the can or bottle to an area in front of the can or bottle, the side wall portions being sufficiently resilient to allow the side wall portions to separate in the event a cross-sectional dimension of the can or bottle exceeds the cross sectional dimension of the holder side wall portions whilst being inserted or carried, and thereby accommodate cans or bottles of varying cross-sectional dimension;
a top portion configured to:
when a can is inserted in the holder, or a bottle having a shoulder that does not exceed the height of the top portion, extend over a top of the can or the bottle shoulder to restrict the can or bottle from moving longitudinally in a substantially upward direction, or
when a bottle is inserted in the holder, press against the rear of the bottle and thereby urge the bottle in a forward direction, causing each of the top portion and the side wall portions of the holder to apply a radially opposing force on the front and rear of the bottle respectively, thereby gripping the bottle and restricting radial and upward longitudinal movement thereof.
